(19) United States
(12) Patent Application Publication
(10) Pub. No.: US 2007/0191969 A1
(43) Pub. Date: Aug. 16, 2007

(54) Automated state change notification

(76) Inventors: Jianying Shi, Oakland Township, MI (US); Steven W. Holland, St. Clair, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/352,915

(22) Filed: Feb. 13, 2006

(51) Int. Cl. G05B 11/01

(52) U.S. Cl. 700/12

(57) ABSTRACT

Methods, systems, and computer program products for providing an automated state change notification. Methods include activating a generic background task that uses open and public communication protocols on a computer controlled device. The state of a computer controlled device is checked via the background task without impacting native software functions on the computer controlled device. It is determined if the state has changed. If the state has changed, information about the state is transmitted to a recipient that is external to the computer controlled device.

### BACKGROUND

Exemplary embodiments relate generally to state change notification, and more particularly, to methods, systems and computer program products for automated state change notification from a computer controlled device.

Typically, computer controlled devices utilize proprietary software to achieve their native functions. To allow external users access to information on these devices via a communication connection, custom proprietary interfaces to the native software have to be developed. The custom proprietary interfaces impact the native software and/or functions on the computer controlled device by interrupting the native device software execution.

Another method of allowing external users access to information on computer controlled devices is via a web server on the computer controlled device. This allows users to access information using a standard web browser, like any ordinary web server on a public site. Web servers are designed to present information to web browsers based on http requests. In this sense, web servers are “passive” and the external users initiate hypertext transfer protocol (“http”) requests when web site addresses are invoked. In general, the external user requests specific information from the computer controlled device and the computer controlled device responds by providing the requested information. This process can become cumbersome when there are several (or hundreds) of computer controlled devices that must be polled for information by the external user.

In an assembly plant, for example, where there may be hundreds of computer controlled devices, engineers and/or assembly plant staff may have to review a massive amount of irrelevant data to determine if there have been any changes in the states of one or more computer controlled devices. In a typical computer controlled device, such as a welding robot, there are more than a thousand data items that impact daily production in terms of cycle time, weld quality, error recovery, and downtime recovery. In many cases, the engineers and assembly plant staff do not know about a deteriorating robot operating condition until the robot has broken down or after welding problems have been discovered.

What is needed is a manner of accessing selected data located on a computer controlled device from an external computer without developing an explicit custom proprietary software interfacing with the native software and functions on the computer controlled device. In addition, it would be desirable for the external computer to receive the selected data only when a state associated with the computer controlled device has changed.

### SUMMARY

Exemplary embodiments relate to methods, systems, and computer program products for providing an automated state change notification. Methods include activating a generic background task that uses open and public communication protocols on a computer controlled device. The state of a computer controlled device is checked via the background task without impacting native software functions on the computer controlled device. It is determined if the state has changed. If the state has changed, information about the state is transmitted to a recipient that is external to the computer controlled device.

Systems for providing an automated state change notification include a generic background task module and a processor in communication with the background task module. The generic background task module uses open and public communication protocols for activating a generic background task on a computer controlled device. The processor includes computer instructions for facilitating activating the background task on the computer controlled device. The state of the computer controlled device is checked via the background task without impacting native software functions on the computer controlled device. It is determined if the state has changed. If the state has changed, information about the state is transmitted to a recipient that is external to the computer controlled device.

Computer program products for automated state change notification include a storage medium readable by a processing circuit and storing instructions for execution by the processing circuit for facilitating a method. The method includes activating a generic background task that uses open and public communication protocols on a computer controlled device. The state of a computer controlled device is checked via the background task without impacting native software functions on the computer controlled device. It is determined if the state has changed. If the state has changed, information about the state is transmitted to a recipient that is external to the computer controlled device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of an exemplary system for automated state change notification according to exemplary embodiments;

FIG. 2 is a process flow diagram that may be utilized to provide automated state change notification according to exemplary embodiments; and

FIG. 3 is a block diagram of an exemplary system for automated state change notification for an industrial robot controller according to exemplary embodiments.

### DETAILED DESCRIPTION OF EXEMPLARY EMBODIMENTS

Exemplary embodiments include automated state change notification that does not impact native device software and functions. The state of a computer controlled device is represented by a collection of data. Examples of computer controlled devices include, but are not limited to: robots, programmable logic controllers, weld controllers, smart automated guided vehicles, and automotive components (e.g., a powertrain control module). The change of the state of a computer controlled device is represented by the change in the data values associated with data elements that make up the state. The change of the state may also be indicated by the presence of a specific combination of data values. The data elements may include, but are not limited to, any of the following: a set of user programmable parameters on the device, real-time data that the device is producing, and a certain combination of conditions of the device. In exemplary embodiments, the state change notification occurs in real-time as the state change event occurs. In addition, the state change notification is selective as the consumers (the recipients) of the notification can define the states and their associated data or conditions.

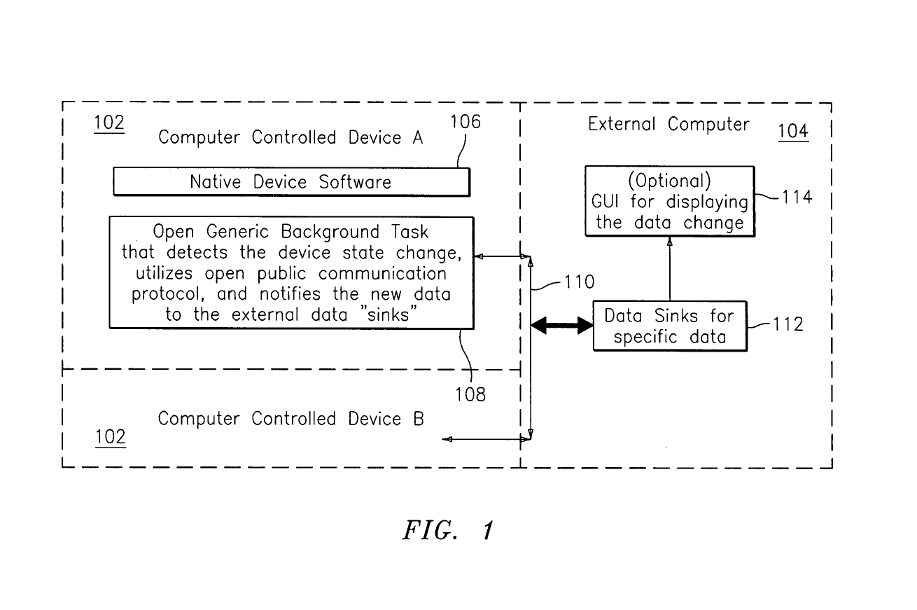

FIG. 1 is a block diagram of an exemplary system for automated state change notification according to exemplary embodiments. It includes one or more computer controlled devices 102 and an external computer 104. Each computer controlled device 102 includes native device software 106 and an open generic background task 108 for detecting a state change in the computer controlled device 102. In exemplary embodiments, the open generic background task 108 utilizes an open public communication protocol and notifies (e.g., transmits) any new data associated with a state change to the data sinks 112 located on the external computer 104. The external computer 104 includes data sinks 112 for the state data as well as an optional graphics user interface (GUI) 114 for displaying the data change.

The external computer 104 and the computer controlled device 102 are in communication via a communication link 110. The communication link 110 may be wired or wireless. In addition, it may include any type of known network including, but not limited to, a wide area network (WAN), a local area network (LAN), a global network (e.g. Internet), a virtual private network (VPN), and an intranet. The network may be implemented using a wireless network or any kind of physical network implementation.

In exemplary embodiments, a user (e.g., recipient) on the external computer 104 establishes a communication connection, using public open communication protocols, via the communication link 110 to the background task 108 that is running on the computer controlled device 102. The external computer 104 may have a communication link 110 to one or more computer controlled devices 102. In exemplary embodiments, the communication link 110 behaves like a “pipe” in that once it is connected, the communication link 110 lasts until it is disconnected. On the external computer 104, the user defines a state by specifying data values and/or conditions on the computer controlled device(s) 102 that require notification to the external computer 102 whenever they change. In addition, the external computer 104 creates data “sinks” (i.e., recipient or storage locations) for the “pipe” connection. For a batch operation, the data selected can be applied to all computer controlled devices 102 or to selected computer controlled devices 102 that are in communication with the external computer 104.

In exemplary embodiments, once the state has been defined (i.e., the data making up the state has been selected) by the external computer 104, data sources are established for the pipe connection (i.e., the communication link 110). The location of the data source(s) on the computer controlled device 102 are determined and communicated to the background task 108. In alternate exemplary embodiments, the background task 108 keeps track of the location of the data elements stored on the computer controlled device 102 and the external computer 104 feeds the names of the data elements making up the state to the computer controlled device 102. The background task 108 then checks the specified data elements for changes and supplies information about the data elements (e.g., the data values) to the external computer 104 when they change.

The background task 108 on the computer controlled device 102 becomes active whenever free machine cycles are available on the computer controlled device 102. The background task 108 determines whether the data values associated with the state have changed. The changed data is then piped (e.g., transmitted), via the communication link 110 to the data sinks 112 on the external computer 104, automatically by the background task 108.

The background task 108 is a software task that is independent of proprietary native software on the computer controlled device 102 and it is generic for the established or future open public communication protocols. In exemplary embodiments, the computer controlled device 102 executes a web server task that supports remote connection (e.g., to the external computer 104 via the communication link 110). One example of the background task 108 is the web crawler task. A web crawler task is a background task that operates in the web server space and communicates to the data consumers via public internet protocols. This generic web crawler task is independent of the proprietary software on the computer controlled device 102, and it can be easily introduced to a computer controlled device 102 without impacting the native function of the computer controlled device 102. This task will crawl the web server for specific pieces of data that have been selected for change notification. The web crawler task does not require any proprietary software change and the task is scheduled at a lower priority. Thus, the task will have a small footprint and enable real-time data notification without impacting native software and functions on the computer controlled device 102. Other examples of open protocols that may be utilized for implementing the generic background task 108 include, but are not limited to, transmission control protocol/internet protocol (TCP/IP), hypertext transfer protocol (HTTP), file transfer protocol (FTP), remote method invocation (RMI), remote procedure calls (RPC) and various wireless application protocols (WAP). The previous listing indicates open protocols that are currently available, however exemplary embodiments are designed to work with any open protocols that are defined and available in the future.

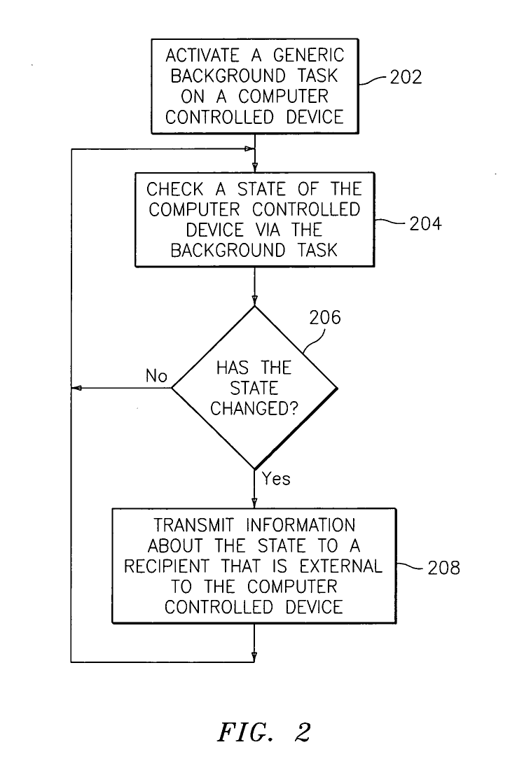

FIG. 2 is a process flow diagram that may be utilized to provide automated state change notification according to exemplary embodiments. At block 202, the generic background task 108 is activated on the computer controlled device 102 whenever free computing cycle becomes available. The generic background task 108 has access to data values associated with data elements stored on the computer controlled device 102. At block 204, the state of the computer controlled device 102 is checked via the generic background task 108. In exemplary embodiments, the definition of the data elements and data values located on the computer controlled device 102 that make up the state are received from the recipient (the person who will receive notification when the state changes). The data values associated with the data elements may include, but are not limited to, data elements that indicate a parameter on the computer controlled device 102, data elements with data values that are produced by the computer controlled device 102, and data elements that indicate a condition of the computer controlled device. In exemplary embodiments, the checking occurs without impacting native software and functions on the computer controlled device.

At block 206 in FIG. 2, it is determined if the state of the computer controlled device 102 has changed. In exemplary embodiments, the state has changed if a data value associated with one or more of the data elements in the state has changed and/or if a data value or a specific combination of data values associated with one or more of the data elements is within a specified range. The specified range may indicate a specific value (e.g., 10), a greater than comparison (e.g., greater than 10), a less than comparison (e.g., less than 10) or both greater and less than comparison (e.g., greater than 10 and less than 15). If it is determined at block 206 that the state of the computer controlled device 102 has not changed, then processing continues at block 204 if the free computation cycle is still available.

If it is determined, at block 206 in FIG. 2, that the state of the computer controlled device 102 has changed, then processing continues at block 208. At block 208, information about the state is transmitted to the recipient. In exemplary embodiments the recipient is located external to the computer controlled device 102. Information about the state may include, but is not limited to: all data values associated with data elements in the state, and a data value associated with the data element(s) that has changed. In exemplary embodiments, a communication link 110 for performing the transmitting is established between the generic background task 108 and the recipient (e.g., a data sink 112). In exemplary embodiments, the communication link 110 is established at the request of the recipient.

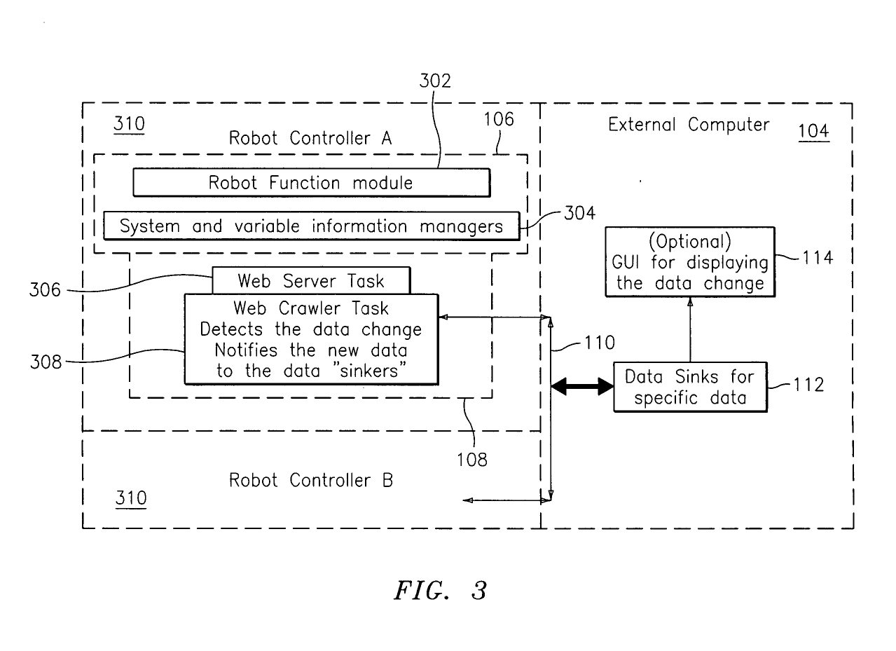

FIG. 3 is a block diagram of an exemplary system according to exemplary embodiments for automated state change notification where the computer controlled device 102 is an industrial robot controller 310. In a manufacturing facility, such as an automotive body shop, hundreds of robots are being utilized in the daily production. It is not realistic and nor is it efficient to expect users (e.g., recipients) to use a web browser to connect to each robot, browse to a specific web page or section of the web page, and then to examine the detail data. The exemplary embodiment depicted in FIG. 3 avoids this process by allowing for automatic data change notification to the recipients via robot web servers 306 and the web crawler task 308 (i.e., the generic background task 108).

The system depicted in FIG. 3 includes one or more robot controllers 310 and an external computer 104. Each robot controller 310 includes native device software 106 (robot function module 302 and system and variable information managers 304) and an open generic background task 108 (web server task 306 and web crawler task 308) for detecting a state change in the robot controller 310. In exemplary embodiments, the open generic background task 108 utilizes an open public communication protocol and notifies (e.g., transmits) any new data associated with a state change to the data sinks 112 located on the external computer 104. The external computer 104 includes data sinks 112 for the state data as well as an optional graphics user interface (GUI) 114 for displaying the data change.

The external computer 104 and the robot controller 310 are in communication via a communication link 110. The communication link 110 may be wired or wireless. In addition, it may include any type of known network including, but not limited to, a wide area network (WAN), a local area network (LAN), a global network (e.g. Internet), a virtual private network (VPN), and an intranet. The network may be implemented using a wireless network or any kind of physical network implementation.

In exemplary embodiments, a user (e.g., recipient) on the external computer 104 establishes a communication connection, using public open communication protocols, via the communication link 110 to the web server task 306 that is running on the robot controller 310. As depicted in FIG. 3, the external computer 104 may have a communication link 110 to one or more robot controllers 102. In exemplary embodiments, the communication link 110 behaves like a “pipe” in that once it is connected, the communication link 110 lasts until it is disconnected.

On the external computer 104, the user defines a state by specifying data values and/or conditions on the robot controller(s) 310 that require notification to the external computer 104 whenever they change. In addition, the external computer 104 creates data “sinks” (i.e., recipient or storage locations) for the “pipe” connection. For a batch operation, the data selected can be applied to all robot controllers 102 or to selected robot controllers 102 that are in communication with the external computer 104.

In exemplary embodiments, once the state has been defined by the external computer 104, data sources are established for the pipe connection (i.e., the communication link 110). The generic background task 108 then checks the specified data elements for changes and supplies information about the data elements (e.g., the data values) to the external computer 104 (via the data sinks 112) when they change. The information is supplied via a transmission over the communication link 110. The data elements in the state may include user settable parameters and/or operating/running parameters that indicate the state of the robot controller 310 operating conditions. Any data accessible via the system and variable information managers 304 can be candidates for the automatic change notification.

The generic background task 108 (e.g., the web crawler task 308 and the web server task 306) on the computer controlled device 102 will be “woken up”, or activated, whenever the data values associated with data elements in the state change. Information about the changed data, such as the data values of the changed data, will be automatically piped, or transmitted, via the communication link 110 to the data sinks 112 (e.g., the recipient) on the external computer 104.

The web crawler task 308 is one example of a specific implementation for detecting and communicating the data change. The web crawler task 308 will crawl the web server 306 for specific pieces of data that have been selected for data change notification (i.e., those included in the state). The web crawler task 308 will be able to detect the data change when activated on the next free computing cycle after the data change has been accepted by the system and variable information managers 304. Thus, the web crawler task 308 will enable the real-time data change notification without impact the native device function

In exemplary embodiments, the general concept is event triggered notification. In this case, the event is the state change of a computer controlled device. In the case of a robot controller 310, the value of a particular piece of data or a certain combination of data or the range of data value has changed. The notification is originated from the robot controller 310. The notification receiver (recipient) is the external computer 104 that is connected to the robot devices and has established the communication link 110. Exemplary embodiments are implemented by utilizing the web server 306 and the web crawler type of task 308 on the robot controller 310 that can detect the device state change event automatically.

Exemplary embodiments may be utilized to provide automatic notification for data elements and/or parameters located on computer controlled devices 102. For data elements and/or parameters that impact cycle time, this may result in quick error recovery of the production line as well as improved cycle time. For computer controlled devices 102 such as welding robots, weld quality may be improved by providing for notification of possible deteriorating conditions before they cause the weld quality to be impacted. Exemplary embodiments may also be utilized inside vehicles, such as automobiles, to notify external computers 104 of important changes in onboard vehicle computer systems.

Exemplary embodiments of the present invention provide automated state change notification without an explicit custom proprietary software interface to native device software. An open, generic background task on the computer controlled device is used for real-time, automated state change notification. For typical computer controlled devices, such as those described herein, tasks are run in a real-time environment. This means that a fixed period of time is assigned as a computing cycle and within this computing cycle, tasks are activated based on their priorities. In exemplary embodiments, the generic background task has a very low priority and is periodically activated to check for the device state change.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing an automated state change notification, the method comprising:
activating a generic background task that uses open and public communication protocols on a computer controlled device;
checking a state of the computer controlled device via the background task without impacting native software and functions on the computer controlled device;
determining if the state has changed; and
transmitting information about the state to a recipient that is external to the computer controlled device if the state has changed.

2. The method of claim 1 further comprising establishing a communication link between the background task and the recipient.

3. The method of claim 1 further comprising receiving a definition of the state from the recipient.

4. The method of claim 1 wherein the state includes one or more data elements stored on the computer controlled device.

5. The method of claim 4 wherein data values associated with the data elements indicate one or more of a parameter on the computer controlled device, data that the computer controlled device is producing, and a condition of the computer controlled device.

6. The method of claim 4 wherein the state has changed if a data value associated with one of the data elements has changed.

7. The method of claim 4 wherein the state has changed if a data value or a combination of data values associated with one or more of the data elements is within a specified range.

8. A system for providing an automated state change notification, the system comprising:
a generic background task module that uses open and public communication protocols for activating a generic background task on a computer controlled device; and
a processor in communication with the background task module and including computer instructions for facilitating:
activating the background task on the computer controlled device;
checking a state of the computer controlled device via the background task without impacting native software and functions on the computer controlled device;
determining if the state has changed; and
transmitting information about the state to a recipient that is external to the computer controlled device if the state has changed.

9. The system of claim 8 wherein the computer instructions further facilitate establishing a communication link between the background task and the recipient in response to a request from the recipient.

10. The system of claim 8 wherein the computer instructions further facilitate receiving a definition of the state from the recipient.

11. The system of claim 8 wherein the state includes one or more data elements stored on the computer controlled device.

12. The system of claim 11 wherein data values associated with the data elements indicate one or more of a parameter on the computer controlled device, data that the computer controlled device is producing, and a condition of the computer controlled device.

13. The system of claim 11 wherein the state has changed if a data value associated with one of the data elements has changed.

14. The system of claim 11 wherein the state has changed if a data value or a combination of data values associated with one or more of the data elements is within a specified range.

15. The system of claim 8 wherein the computer controlled device is one or more of a robot, a programmable logic controller, a weld controller, an automated vehicle and an automotive component.

16. A computer program product for providing an automated state change notification, the computer program product comprising:
a storage medium readable by a processing circuit and storing instructions for execution by the processing circuit for facilitating a method comprising:
activating a generic background task that uses open and public communication protocols on a computer controlled device;
checking a state of the computer controlled device via the background task without impacting native software and functions on the computer controlled device;
determining if the state has changed; and
transmitting information about the state to a recipient that is external to the computer controlled device if the state has changed.

17. The computer program product of claim 16 wherein the method further comprises establishing a communication link between the background task and the recipient in response to a request from the recipient.

18. The computer program product of claim 16 wherein the method further comprises receiving a definition of the state from the recipient.

19. The computer program product of claim 16 wherein the state includes one or more data elements stored on the computer controlled device and the data values associated with the data elements indicate one or more of a parameter on the computer controlled device, data that the computer controlled device is producing, and a condition of the computer controlled device.

20. The computer program product of claim 16 wherein the state has changed if a data value associated with one of the data elements has changed.
